(19) United States
(12) Patent Application Publication
(10) Pub. No.: US 2010/0181313 A1
(43) Pub. Date: Jul. 22, 2010

(54) GARBAGE CONTAINER PROVIDED WITH A COMPACTOR

(76) Inventor: Anna Turina, S. Maria Hoe (IT)

Correspondence Address: Lonnie R Drayer, 6504 Cathedral Oaks Drive, Plant City, FL, 33565, US

(21) Appl. No.: 12/668,206

(22) PCT Filed: Jul. 10, 2008
(86) PCT No.: PCT/IB08/01803

§ 371 Date: Mar. 16, 2010

(30) Foreign Application Priority Data
Jul. 13, 2007 (IT) 07425434.3

(51) Int. Cl. B65F 1/16; B65D 43/16; B65D 43/26; B65D 51/24; B30B 7/00

(52) U.S. Cl. 220/212; 220/263; 220/694; 100/233

(57) ABSTRACT

The present invention concerns a container (1) for wastes (2), in particular for collecting wastes in the domestic field. The container comprises a main body (3), a lid (4) associable to the main body and a compactor (5) provided with a pressing element (6), moveable within the main body (3) to compact the wastes (2) collected therein. The pressing element is manually operated from the outside of the container (1) through suitable mechanical means. Advantageously, the operating means comprises a lever (8, 9) which can be operated by the user to vary the vertical position and the inclination of the pressing element.

### FIELD OF THE INVENTION

The present invention relates to a garbage container provided with a compactor, in particular relates to a garbage container, mostly for domestic use, provided with a manual compactor for wastes.

### PRIOR ART

Several kinds of containers have been made available provided with a compactor, to be operated by the user, which allow for reducing the volume of the collected garbage.

The Italian utility model application IT MI 2004U000043 discloses a container for collecting domestic wastes, provided with a main body, in which for instance a bag can be positioned, and a lid connected to said body. The lid is provided with a compactor manually operable from its outside. The compactor comprises a pressing element, that is a disk intended to compact the wastes collected in the container body, a rod for operating the pressing element, slidingly arranged through the lid, in a central position, and a handle fixed to the rod. Normally the pressing element remains in an upraised initial position. The user operates the compactor by vertically lowering the handle, thus lowering the operating rod, and pressing the wastes with the pressing element, which is brought into a final lowered position. A resilient element brings the pressing element back in its initial position when the user stops applying a force on the handle. A similar solution is also disclosed in JP 4189201.

The German patent application DE-A-19604302 discloses a garbage container provided with a compactor linked to the lid, in a central position. The lid itself is laterally hinged to the container body. The compactor comprises a pressing element, having the shape of a disk, vertically moveable within the container by means of screw mechanisms, or by virtue of the push exerted by a spring.

The traditional solutions provides several drawbacks. Firstly, the assembly formed by the pressing element and the related operating rod is cumbersome, i.e. it excessively reduces the volume that can be used for inserting the wastes into the container. In particular, when the lid is hinged to the container body and is rotated to access the internal volume of the container, the pressing element partially obstructs the container inlet, thereby making difficult to insert cumbersome wastes.

Secondarily, the weight of the compactor increases the weight of the lid, which is thereby uncomfortable to be upraised, for instance when replacing the garbage bag.

Another drawback of the traditional solutions comes from the fact that the force needed for effectively operating the compactor may be high, to the detriment of the practicality of the functioning.

### SUMMARY OF THE INVENTION

It is an object of the present invention to provide a garbage container, provided with respective compactor, which overcomes the drawbacks of known solutions in a simple and effective way, being at the same time economic to manufacture and easy to use.

It is another object of the present invention to provide a garbage container, provided with a compactor, which can be easily operated by the user with minimum strength.

These and other objects are achieved by the present invention which relates to a container according to claim 1.

The container comprises a hollow main body, wherein, for instance, a bag can be inserted for collecting garbage or directly wastes, a lid, and a compactor provided with a pressing element which is moveable within the main body to compact the wastes collected therein. The pressing element, for instance a disc made of a plastic material or in metal, is manually operated from the outside of the container through suitable mechanical means. Advantageously, the operating means comprises a lever which can be operated by the user to vary the vertical position and the inclination of the pressing element. In this way, apart from effectively compacting the collected wastes, it is possible to rotate the pressing element into a position of minimum obstruction of the container body inlet, thus avoiding chocking the same during insertion of the wastes.

In general, the container may have different shapes and comprises a base and one or more side walls. For instance, the container may have a general cylindrical shape, or may have a section being square, rectangular, hexagonal, etc. The base may be closed, for example it may be a planar surface, or a concave surface, that is slightly curved toward the container inside. Alternatively, the base may be open, for example it may be shaped as a ring, or it may have the shape of a frame being square, rectangular, hexagonal, etc.

The side wall of the container may be closed, or it may provide for one or more lateral openings, for instance of the type for allowing air circulation within the garbage containers. Alternatively, the side wall may be formed by one or more vertical beams coupled one to the other, other than the base and an upper ring or a frame which define the container inlet, so as to leave wide openings between two next beams. The side wall of the container may also be formed as a rigid net.

The container may also comprise an upper lid hinged to the side wall or to the upper ring/frame. Alternatively, the container lid is separated and can be engaged to the container at its upper inlet. For example, the lid is hinged to a portion which can be fitted, at least partially, onto the container inlet.

According a first preferred embodiment of the container of the present invention, the movement of rotation and the vertical movement are one dependent upon the other.

The compactor lever is a rigid arm coupled to the pressing element and hinged to the main body of the container, or hinged to the lid which can be coupled to the container in a stable way. The pressing element may have different shapes, for instance it can be a disc, a plate being square, rectangular or hexagonal, a curved element, an element having the shape of an asterisk, etc., and is coupled to the lever by means of a second rigid arm, being straight or curved. Rotation of the lever about the respective hinge causes the pressing element to low/raise within the main body of the container. At the same time, inclination of the pressing element with respect to the vertical changes correspondingly. Preferably, the connecting arm between the pressing element and the lever is integral with the same lever and extends from a central portion thereof, thereby sliding through the lid of the container. The user grips the lever at the end opposite to the respective hinge. The configuration of the assembly constituted by the lever, the connecting arm of the pressing element and the same pressing element is typical of a lever of the second type, which is always advantageous for the user. The point wherein the wastes generate a resistive force is interposed between the lever hinge and the point wherein the user exerts the force.

The compactor lever overlies, at least partially, the (external) upper surface of the lid, so as to minimize the size of the container and optimize its design.

Preferably, also the lid is hinged to the main body of the container, for instance to the same hinge of the compactor lever, interposed between the lever and the pressing element.

By rotating the compactor lever upward, the pressing element is moved into abutment with the lower surface of the lid. A further rotation of the lever causes the lid to move upwardly, that is to open by rotating about the respective hinge. When the compactor lever is brought into its initial position, by rotating the same downwardly, the pressing element presses the wastes collected within the body of the container. The pressing element travel ends when the compactor lever abuts the upper surface of the lid, which acts as an end-of-travel for the same laver.

Alternatively, the lid, which is hinged to the main body of the container, can be opened by rotating the same trough a pedal-operated opening mechanism.

Such first embodiment of the container has the advantage of being easy to use, in that the weight of the compactor is mostly supported by the hinge of the respective lever. The force that the user has to exert both to compact the wastes and to upraise the compactor is thus minimal.

According to an alternative embodiment of the container according to the present invention, the movement of rotation of the pressing element, with respect to the vertical, and the vertical movement are independent one with respect to the other. The lever is coupled to the pressing element by means of an articulated system, slidingly mounted through the lid, intended to transmit to the pressing element the translating vertical movements and the rotating vertical movements imparted the user to the compactor lever. Also in this embodiment the lid can be directly hinged to the container, for instance at the related inlet, or can be hinged to a support, separated from the container, which can be fit onto the lateral walls thereof.

The articulated system comprises two rigid parallel rods, each having a first end hinged to the lever of the compactor and a second end hinged to the pressing element. The rods are hinged at different portions of the lever and the pressing element. The two rods extend through the container lid, being slidable within a proper seat.

The lever can be operated by the user to rotate the pressing element between a horizontal position, suitable to compact the wastes, and a position inclined with respect to the vertical, suitable to favourite insertion of the wastes within the main body of the container. Rotation imparted to the compactor lever is transmitted identical to the pressing element by the articulated system. In the same way, the translation vertical movements imparted to the compactor lever are transmitted identical to the pressing element, that is the lever can be translated vertically to move the pressing element between an upraised position, wherein the lid acts as an end-of-travel for the pressing element, and a lowered position, suitable to compact the wastes, wherein the lid acts as an end-of-travel for the same lever. The user may translate or rotate the compactor lever, thus independently translating or rotating the pressing element with respect to the vertical, by imparting to the lever respectively a rotating movement about the hinges of the articulated system, or a translating vertical movement with respect to the seat in the lid.

Opening of the lid is achieved by raising the pressing element, by means of the compactor lever, above its upraised position.

The first and the second embodiment may be provided with means to block the position of the pressing element with respect to the container lid in one or more preset positions. For example, such means comprises a locking member lodged within a seat of the lid and biased by a spring into one or more slots provided in the supporting arm of the pressing element or in one of the rods of the articulated system. By applying a force onto the compactor lever to raise or to low the same, the user overcomes the force of the spring, thereby disengaging the locking member from the slots.

According to a third embodiment of the present invention, the compactor may be manufactured separately from the main body of the container. In this way the compactor may be sold separately so as to be coupled to existing containers of the user. For instance, the compactor may be commercialized together with a lid which can fit common containers for domestic use.

The container according to the present invention allows for effectively compacting the collected wastes, with minimum force, being at the same time easy to use, cheap and reliable.

Thanks to the pressing element being tiltable with respect to the vertical, insertion of the wastes within the main body of the container is easy, that is the pressing element obstructs the container inlet only to the minimum extent. This feature makes the container according to the present invention particularly suitable for the domestic use, for example having a volume comprised between 15 and 40 litres.

### BRIEF DESCRIPTION OF THE DRAWINGS

Further aspects and advantages of the present invention will be more evident from the following illustrative and non limitative description, made with reference to the schematic enclosed drawings, wherein:

FIGS. 1-4 show a section of the first embodiment of the container according to the present invention, in an operating sequence;

FIG. 5 is a partial perspective view of a detail of the container shown in FIGS. 1-4;

FIGS. 6-8 are a section view of a second embodiment of the container according to the present invention, in an operating sequence;

FIG. 9 is a section view of a detail of the container according to the present invention;

FIG. 10 is a schematic view of a third embodiment of the container according to the present invention;

FIG. 11 is a schematic view of the third embodiment of the container according to the present invention;

### DETAILED DESCRIPTION OF THE INVENTION

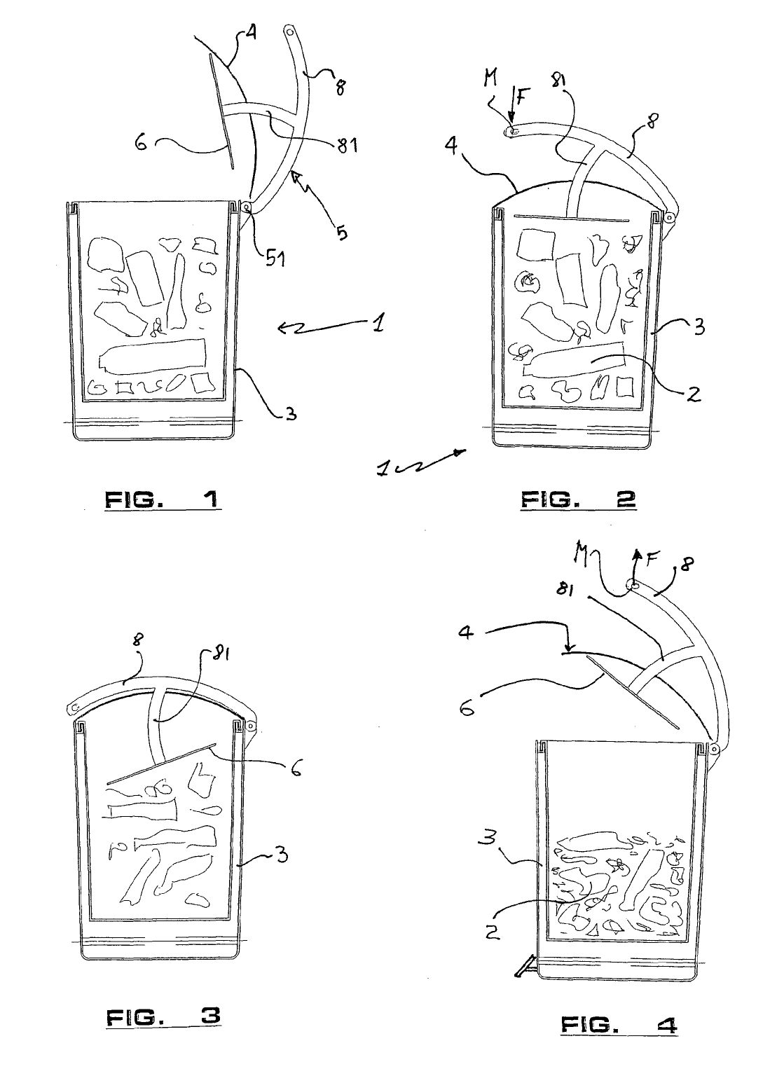

With reference to the FIGS. 1-5, it is shown a container 1 according to a first embodiment of the present invention. The container 1 comprises a main body 3 intended to lodge waste 2 of various types, preferably in a plastic bag inserted within the body 3. The container also comprises a lid 4 moveable to allow insertion of wastes 2 into the container.

The main body 3 of the container may have a generic circular section, or it may be square, rectangular, hexagonal, etc. The base of the container may be closed, open, flat or curved toward the inside of the same container 1.

The side wall of the main body 3 may be closed, or may provide for one ore more openings. For instance, the side wall of the body 3 may be shaped as a rigid net having small or large meshes. The openings allow for circulation of the air.

The openings on the side wall of the main body 3 may be wide to the extent that the same side wall may be configured as one or more vertical posts which support the container inlet, for instance a ring or a frame.

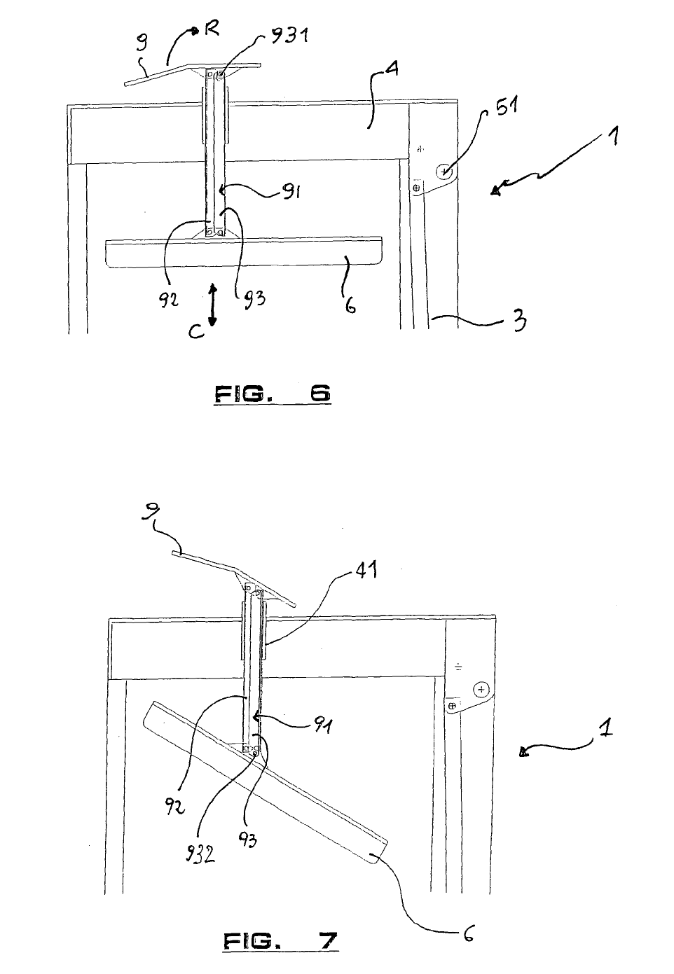

The container 1 is provided with a compactor 5, of the manual type, having the function of minimizing the volume of the wastes 2 collected within the body 3. The compactor 5 comprises a rigid operating lever 8, which can be handled by the user, supporting a pressing element 6 being moveable toward the wastes 2 contained within the body 3 to exert on the same a compressing force. Coupling between the arm 81 and the pressing element 6 is rigid, having no degrees of freedom. The pressing element 6 is a substantially plane element, for instance a metallic or plastic sheet, or a curved element. Preferably the pressing element 6 is an element shaped as a disc if the container 1 is circular, or it is a square sheet if the container 1 has a square base. In FIG. 5 is shown a pressing element 6 having a square shape (in dotted line).

In the embodiment shown in the FIGS. 1-5, the lever 8 is hinged to the body 3 of the container 1, in particular to the side wall. The hinge is referred to with the number 51 and preferably is provided in correspondence of the upper edge of the body 3, that is in correspondence of the container inlet 1. If the side wall of the container 1 is made of a single vertical post, the hinge 51 is provided on that post, preferably at its upper portion. The pressing element 6 is coupled to the lever 8 of the compactor by means of a rigid arm 81 which extends through the lid 4 starting from an intermediate portion of the same lever 8. In the embodiment shown in the FIGS. 1-5 the arm 81 is curved. Alternatively the arm 81 may be straight. Coupling of the arm 81 with the lid 4 is slidable, that is the lid 4 is provided with a through hole in which the arm 81 slides. If the arm 81 is straight, the hole of the lid 4 is elongated to allow insertion of the arm 81. The assembly constituted by the operating lever 8, the arm 81 and the pressing element 6 is configured as a second type lever, which is always advantageous for the user. In other words, the user exerts an activation force on the end of the lever 8 opposite to the hinge 51, and the resistive force provided by the wastes 2 while being compacted by the pressing element 6 is located on a point of the lever 8 intermediate between the hinge 51 and the end gripped by the user (practically on the joint between the arm 81 and the lever 8).

The lid 4 may simply rely on the body 3 of the container 1, but preferably it is hinged.

In the embodiment shown in the FIGS. 1-5, the lid 4 is hinged on the same hinge 51 of the lever 8 of the compactor 5.

The FIGS. 1 to 4 show the operating sequence of the compactor 5. In particular, the FIG. 1 shows the container 1 having the lid 4 lifted. Also the compactor 5 is raised to allow insertion of the wastes 2. It has to be noted that even if the lever 8 is raised few grades with respect to the upper edge of the body 3, the pressing element 6 remains oblique to expedite insertion of the wastes 2 within the container 1, i.e. it does not obstruct, if not only to a minimum extent, the inlet of the container 1.

The FIG. 2 shows the container 1 with the compactor 5 partially lowered by the user applying a force F, directed downward, on the end M of the lever 8 opposite to the hinge 51. The lid 4 closes the body 3 of the container and the pressing element 6 is taken into abutment with the wastes 2.

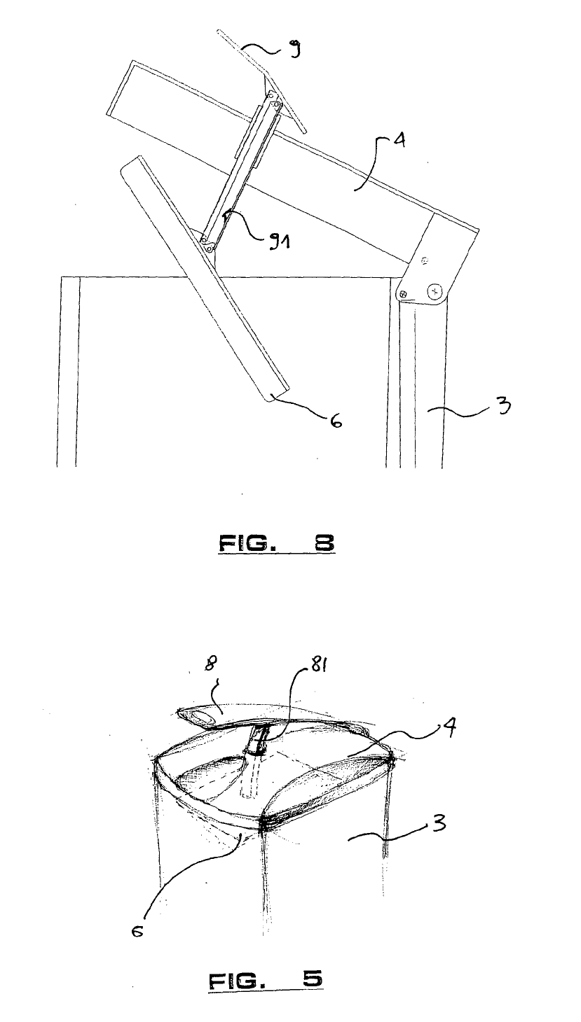

Further pressing by the user is transmitted by the pressing element 6 to the wastes 2, which are compacted as shown in FIG. 3. The wastes 2 may be compacted whenever the container 1 is filled with new wastes.

The FIG. 4 shows a container 1 in a configuration successive to the phase of compacting the wastes 2. The user exerts a lifting force F, directed upward, so as to raise the compactor 5. When the pressing element 6 is lead into abutment against the lower surface of the lid 4, also the lid 4 is rotated to get open. The movement of vertical displacement of the pressing element 6 and that of rotation about a vertical line are not independent one from the other, but are both caused by rotation of the lever 8 about the hinge 51.

The container 1 shown in FIGS. 1-5 is simple to manufacture, in particular when on the same hinge 51 are mounted the lid 4 and the compactor 5, and is simple to use, being effective also with minimum force by the user.

The FIGS. 6-8 refer to a second embodiment of the container according to the present invention wherein the vertical displacement of the pressing element 6 and rotation about a vertical line are independent one from the other.

The operating lever 9 of the compactor 5 is couplet to the pressing element 6 by means of an articulated system 91 slidable in a suitable seat 41 of the lid 4, preferably provided in central position.

The articulated system 91 allows to transfer to the pressing element 6 the vertical displacements and rotations imparted by the user to the lever 9. In the embodiment shown in the FIGS. 6-8, the articulated system 91 comprises two parallel arms 92, 93, both being hinged to the ends, respectively to the lever 9 and the pressing element 6. The articulated system 91 is slidable in the seat 41 provided within the lid 4.

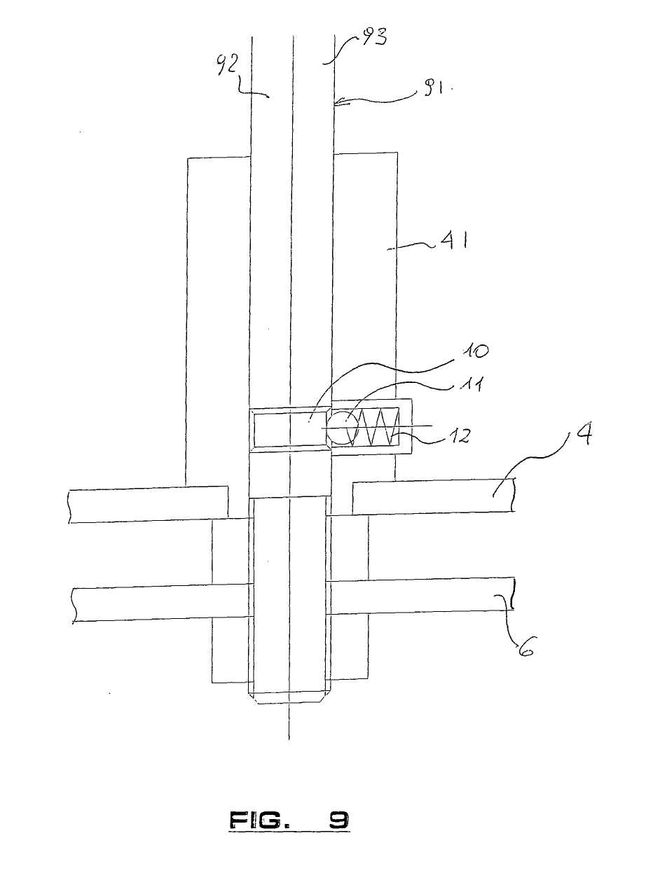

Any rotation imparted to the lever 9 in the direction of the arrow R (FIG. 5), about the hinge 931 of the arm 93, causes the arm 92 to move upwardly and the pressing element 6 to rotate about the hinge 932 (FIG. 7). In this way the pressing element 6 is inclined with respect to the vertical line. By further upraising the lever 9, as shown in FIG. 8, the lid 4 gets opened.

Advantageously, the pressing element 6 is inclined with respect to the vertical line to facilitate insertion of the wastes within the body 3 of the container 1, thereby obstructing the container inlet only to a minimum extent.

Any rotation of the lever 9 in the opposite direction causes the lid 4 to close and, thereafter, the pressing element 6 to rotate in a substantially horizontal position.

By lowering the lever 9, the pressing element 6 is pushed against the wastes 2, to compact the same (direction C in FIG. 6). By raising the lever 9 with respect to the lid 4, the pressing element 6 is brought in abutment against the lower surface of the lid 4, obstructing only partially the inlet of the container 1.

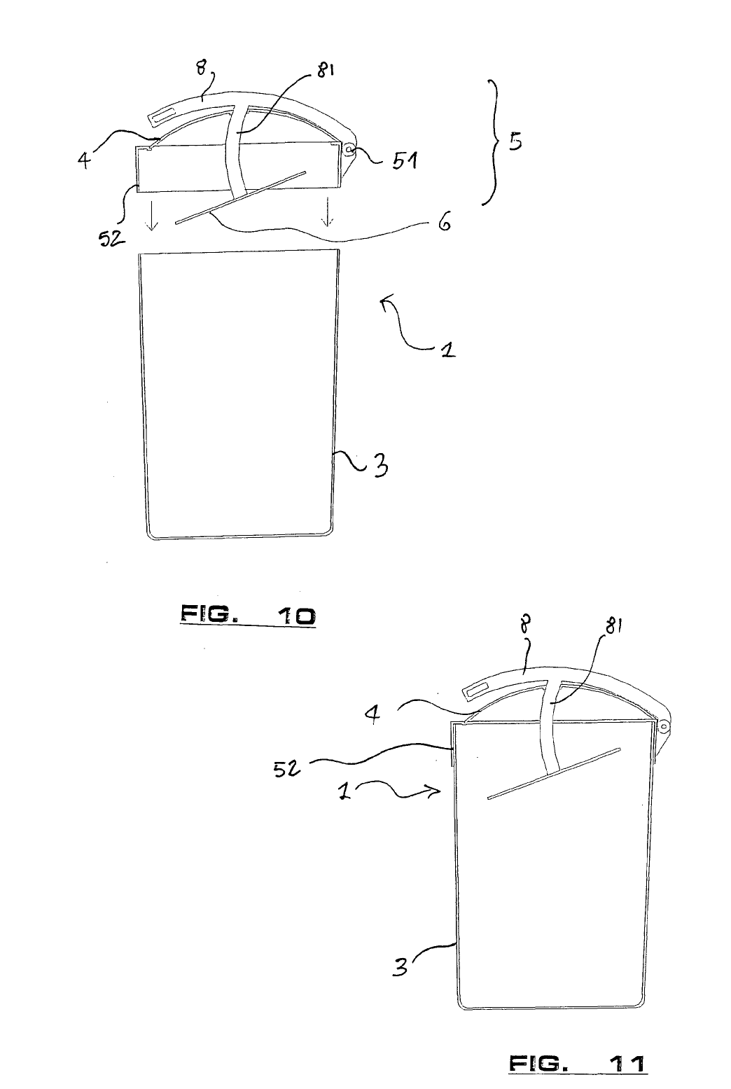

The FIG. 9 shows a device suitable for blocking the stroke of the arm 81 or articulated system 91 with respect to the lid 4, in one or more preset positions.

The articulated system 91, or the arm 81, is provided with at least a groove 10. The seat 41 of the lid is provided with an element 11 intended to engage the seat, or the seats, 10. The element 11 permits to block the pressing element 6 in one or more preset positions with respect to the lid 4 of the container. In particular, the element 11 is a pawl or a metallic sphere (FIG. 9), biased by an elastic element 12, for instance a spring, to engage the grooves 10. The bias of the elastic element is minimum and the user can easily disengage the element 11 form the seat 10 simply by raising or lowering the lever 8 or 9 with respect to the lid 4.

The FIGS. 10 and 11 show a third embodiment of the container according to the present invention, wherein the compactor 5 is manufactured as a separate element from the body 3 of the container. In this way the compactor 5 may be sold separately from the body 3 of the container, for instance together with an universal lid 4, and may be applied to containers already used by the users.

The FIG. 10 shows a compactor 5 in the phase of coupling with the body 3 of the container 1, while the FIG. 11 shows the compactor 5 which fits (that is it overlaps) onto the edge of the body 3 of the same container, i.e. when the coupling is accomplished. The higher is the overlapping of the base 52 of the compactor onto the inlet of the body 3 of the container, the higher is the stability of the coupling.

The container 1 according to the present invention is simple to manufacture and, more than all, it allows to effectively compact the wastes 2 collected therein, without the pressing element 6 interfering with insertion of the same wastes.

1. A container for waste comprising a main body, a lid to be coupled to said main body, a compactor provided with a pressing element, which is moveable within the main body to compact the waste collected therein, and means for manually operating the pressing element, said means being located outside of the container and comprising a lever operable by a user to vary the vertical position and the inclination of said pressing element.

2. The container according to claim 1, wherein said lever is a rigid arm attached to said pressing element and hinged to the main body of the container, and rotation of the lever causes the pressing element to move vertically within the main body of the container.

3. The container according to claim 2, wherein said lever is hinged to the main body of the container at an inlet edge.

4. The container according to claim 1, wherein said lever is a rigid arm attached to the pressing element and hinged to the lid fixable to said main body of the container, and rotation of the lever causes the pressing element to move vertically within the container.

5. The container according to claim 4, wherein said lever is hinged to a base of the lid and the lid is at least partially overlapping an external surface of the main body of the container.

6. The container according to claim 2 wherein said lever is at least partially overlapping an external upper surface of the lid and is provided with a portion that extends through the lid for supporting said pressing element.

7. The container according to claim 1 wherein said lid is directly hinged to the main body of the container interposed between said lever and said pressing element, and is opened by rotating the same using said lever.

8. The container according to claim 7, wherein said lid is rotated to an open position by a pedal-operated mechanism.

9. The container according to claim 1, wherein said lever engages the pressing element by means of an articulated system extending through the lid, the articulated system transmits to the pressing element vertical and rotational movements imparted to the lever by a user.

10. The container according to claim 9, wherein said lever is moveable to rotate said pressing element between a horizontal position, suitable to compact the waste, and a position inclined with respect to the horizontal position, suitable to accommodate insertion of waste into the main body of the container.

11. The container according to claim 10, said lever is is used to move said pressing element between an upraised position, in which an interior surface of the lid abuts the pressing element, and a lowered position in which waste in the main body of the container is compacted with an exterior surface of the lid (4) acting as a stop for the lever.

12. The container according to claim 11, wherein said lid may be opened by raising the pressing element by elevating the lever above the upraised position.

13. The container according to claim 1, further comprising a means for maintaining a position of the pressing element with respect the lid.

14. The container according to claim 1 wherein said lid is hinged to a base fixable to the main body of the container interposed between said lever and said pressing element, and is opened by rotating the same using said lever.

15. A device comprising a container for waste that is equipped with a manual means for compacting waste contained in the container wherein the container comprises:
a main body having an open top; and
a lid for covering the open top of the main body;
and wherein the manual means for compacting waste comprises:
a pressing element that is moveable within the main body to compact waste located therein; and
a means located outside of the container for manually moving the pressing element, said means being a lever at least partially overlapping an external upper surface of the lid and provided with a portion that extends through the lid for connecting said lever to said pressing element, said lever hinged to or commonly hinged with the lid.

16. The container according to claim 15, wherein said lever is hinged to a base of the lid and the lid is at least partially overlapping an external surface of the main body of the container.

17. A device comprising a container for waste that is equipped with a manual means for compacting waste contained in the container wherein the container comprises:
a main body having an open top; and
a lid for covering the open top of the main body;
and wherein the manual means for compacting waste comprises:
a pressing element that is moveable within the main body to compact waste located therein; and
a means located for manually moving the pressing element, said means being a lever at least partially overlapping an external upper surface of the lid, said lever engages the pressing element by means of an articulated system extending through the lid to the pressing element and transmitting to the pressing element vertical and rotational movements imparted to the lever by a user, said lever hinged to or commonly hinged with the lid.

18. The device according to claim 17, wherein said lever is moveable to rotate said pressing element between a horizontal position, suitable to compact waste, and a position inclined with respect to the horizontal position, suitable to accommodate insertion of waste into the main body of the container.

19. The device according to claim 17, wherein said lid may be opened by raising the pressing element by elevating the lever.

20. The device according to claim 17, further comprising a means for maintaining a position of the pressing element with respect the lid.
